(19) United States
(12) Patent Application Publication
(10) Pub. No.: US 2013/0038800 A1
(43) Pub. Date: Feb. 14, 2013

(54) Universal User Interface App and Server

(71) Applicant: Ben YOO, Glendale, CA (US)

(72) Inventor: Ben YOO, Glendale, CA (US)

(21) Appl. No.: 13/252,967

(22) Filed: Oct. 4, 2011

Related U.S. Application Data
(60) Provisional application No. 61/404,398, filed on Oct. 4, 2010.

(51) Int. Cl. H04W 4/00; H04N 5/44

(52) U.S. Cl. 348/734; 455/420; 348/E05.096

(57) ABSTRACT

A method and system for universal user interface is provided. The method comprises steps for downloading from a web server and installing a universal user interface App software (UUIA) to a mobile device of a user, the user's indicating a type of a connected device on the UUIA, the mobile device's being connected to a web server, the user's identifying the connected device on the UUIA, the web server's searching a database to retrieve and install a driver for the connected device, the user's selecting the type of the connected device on the UUIA, and the UUIA's providing a universal user interface for the connected device on the mobile device.

### RELATED APPLICATION

This application is a non-provisional application of U.S. Provisional Patent Application Ser. No. 61/404,398 for “Universal User Interface App and Server” filed on Oct. 4, 2010,

### BACKGROUND OF THE INVENTION

The present invention relates to user interfaces for devices of different categories.

Considering the wide range of devices used in everyday lives of these days, a need for a such interface has been present for a long time. This invention is directed to solve these problems and satisfy the long-felt need.

### SUMMARY OF THE INVENTION

The present invention contrives to solve the disadvantages of the prior art.

An aspect of the invention provides a method for universal user interface.

The method comprises steps for:

downloading from a web server and installing a universal user interface App software (UUIA) to a mobile device of a user;

the user's indicating a type of a connected device on the UUIA;

the mobile device's being connected to a web server;

the user's identifying the connected device on the UUIA;

the web server's searching a database to retrieve and install a driver for the connected device;

the user's selecting the type of the connected device on the UUIA; and

the UUIA's providing a universal user interface for the connected device on the mobile device.

The step of downloading may comprise a step of accessing the Internet.

The type of connected device may comprise a smart TV, a home security system, and a home power control module.

The mobile device may be configured to perform functions of a remote controller for the smart TV, and wherein the functions comprises controlling volume and changing channels.

The mobile device may be configured to perform functions of a keyboard, a touch pad, and a gyration mouse for the smart TV.

The functions may be provided though interface of the mobile device, and the interface of the mobile device may comprise a touch screen, a plurality of buttons, and a plurality of speakers and microphones.

The mobile device may be configured to perform functions for the home security system and the universal home power control module of a house, and the functions may comprise changing temperature of the house, setting schedule for a water heater in the house, monitoring the house using IP cameras installed in the house, open/closing a garage door, turning on or off a stove in the house, and setting schedule for a water sprinkler system in the house.

The database may be provided in the web server.

The step of identifying may comprise a step of selecting a name of manufacturer and a model number of the connected device.

The step of downloading may comprise a step of the user's indicating an OS platform of the mobile device.

The universal user interface may be substantially same for the connected devices of different manufacturers and models.

The method may further comprise a step of controlling the UUIA from a remote computer via the Internet.

The step of controlling may comprise steps for:

signing up on the UUIA and the web server after installing the UUIA in the mobile device;

creating a user account with a user ID and a password;

logging in to the user account; and

performing controlling functions.

The controlling functions may comprise functions for:

freezing the use of the UUIA for a certain period of time;

halting the operation of the UUIA permanently;

recovering information from the mobile device and storing the information in the web server; and

deleting information in the mobile device. Another aspect of the invention provides a universal user interface system, comprising:

a mobile device;

a UUIA installed in the mobile device; and

a web server having a database having a plurality of drivers for a plurality of connected devices,

wherein the UUIA provides a universal user interface for the connected devices of a given type,

wherein the UUIA is downloaded from the web server and installed in the mobile device,

wherein the UUIA accesses the web server and downloads a driver for a connected device therefrom.

The connected device may comprise a smart TV, a home security system, and a home power control module.

The system may further comprise a isecure module for accessing and controlling the UUIA of the mobile device from a remote computer.

The isecure module may be for signing up on the UUIA and the web server after installing the UUIA in the mobile device, creating a user account with a user ID and a password, logging in to the user account, and performing controlling functions.

The controlling functions may include:

freezing the use of the UUIA for a certain period of time;

halting the operation of the UUIA permanently;

recovering information from the mobile device and storing the information in the web server; and

deleting information in the mobile device.

The advantages of the present invention are: (1) the UUIA can accommodate a type of connected devices with a univeral user interface; and (2) the UUIA can make the user interface substantially same to the user regardless of manufacturers and models.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing a universal user interface App according to an embodiment of the invention;

FIG. 2 is a schematic diagram showing a UUIA with drivers for connected devices according to another embodiment of the invention;

FIG. 3 is a schematic diagram showing a URCA according to still another embodiment of the invention;

FIG. 4 is a schematic diagram showing a HASA according to still another embodiment of the invention;

FIG. 5 is a schematic diagram showing a UACA according to still another embodiment of the invention;

FIG. 6 is a schematic diagram showing a UOGA according to still another embodiment of the invention; and

FIG. 7 is schematic diagram showing a UOGA according to still another embodiment of the invention.

### DETAILED DESCRIPTION OF THE INVENTION

The U.S. Provisional Patent Application Ser. No. 61/404,398 for “Universal User Interface App and Server” filed on Oct. 4, 2010 is incorporated by reference into this disclosure as if fully set forth herein.

Our objective is to develop a de facto standard universal user interface App for all categories of connected device manufactured by different manufacturers.

The App is a software application developed with the Application Programming Interface (“API”) provided by mobile operating system providers such as Apple for ios, Google for Android and Microsoft for Phone 7. Mobile OS is used on mobile device such as smart phones, ipod touch, ipad, tablets and etc.

A driver is software that operates the connected device. It is developed by our software programmers with SDK (software development kit) provided by manufacturer of the connected device.

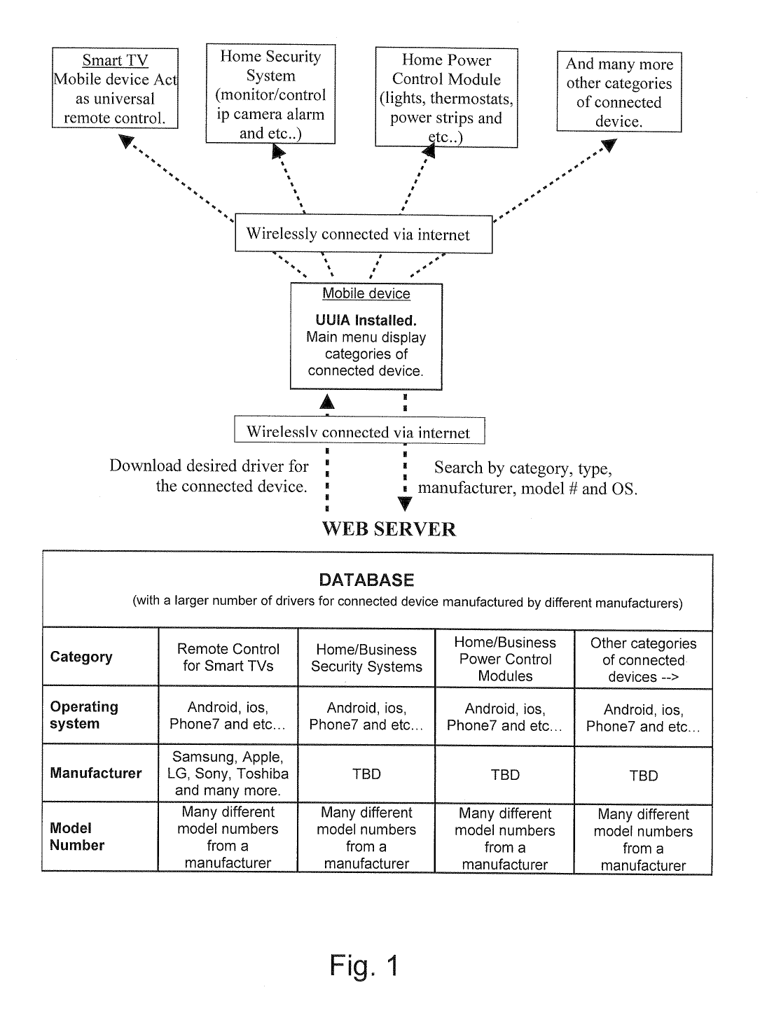

As shown in FIG. 1, the connected device are consist of connected TV (“Smart TV”), connected home appliances, networked security cameras and sensors, HVAC equipment, ITS infrastructure, and etc. All connected via internet wirelessly or wired.

Many drivers will be developed by our software programmers in different categories, type, manufacturers and model number of connected device. These drivers are developed by our software programmers with SDK (software development kit) provided by each manufacturer of the connected device. Each category or type of connected device will use same user interface regardless of manufacturer of the connected device. Hence, users can enjoy same user interface for all connected device in same category or in same type.

The App is linked to a database (or databases) contains drivers for a large number of different categories of connected device manufactured by different manufacturers worldwide.

A user can download the Universal User Interface App (“UUIA”) software to their mobile device from our web server by indicating the OS platform of mobile device.

A user can configure UUIA, by indicate category (type) of the connected device and then mobile device is connected to our web server. Then the user indicates the name of manufacturer and model number of a connected device.

The web server then searches the database to retrieve appropriate driver for the desired connected device.

In operating the UUIA, a user select a category of the connected device, then monitor, control and enjoy the same user interface regardless of the manufacturer and model number of the connected device.

By being able to use same user interface App for each category of connected device, user does not have to learn how to use new App each time user changes the manufacturers of connected devices. With more than one connected devices in the same category, user can use same user interface for the connected device manufactured by different companies.

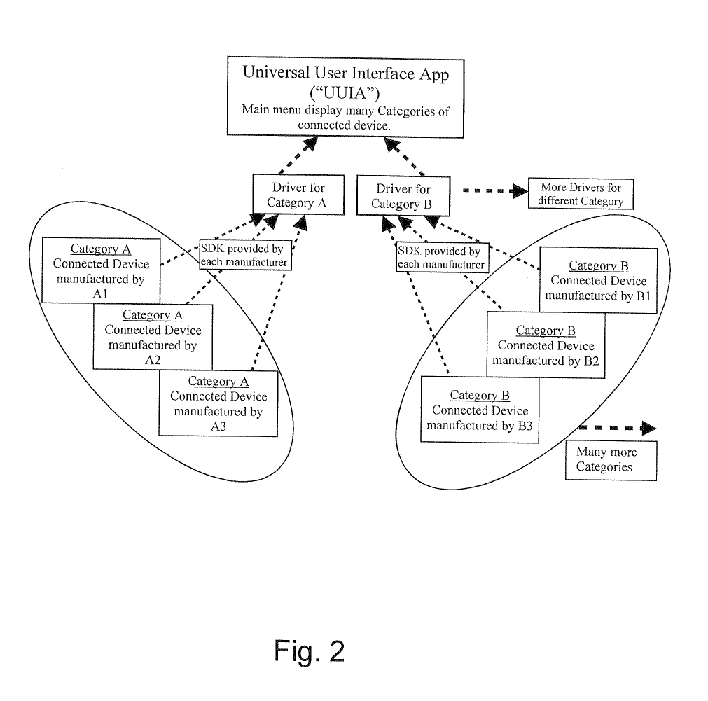

Many drivers will be developed by our software programmers in different categories, type, manufacturers and model number of connected device. These drivers are developed by our software programmers with SDK (software development kit) provided by each manufacturer of the connected device as shown in FIG. 2. Each category or type of connected device will use same user interface regardless of manufacturer of the connected device. Hence, users can enjoy same user interface for all connected device in same category or in same type.

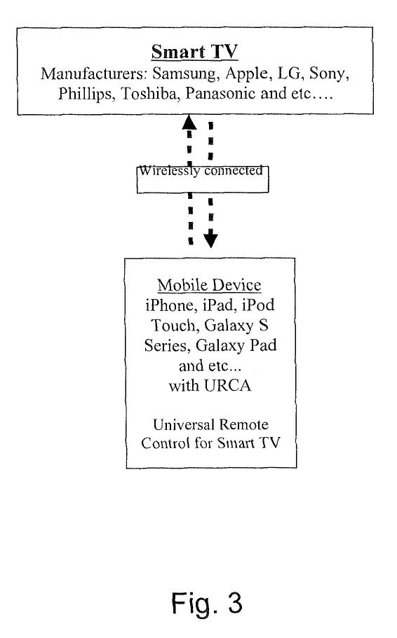

FIG. 3 shows a Universal Remote Control App (“URCA”) for Smart TV.

As part of a category for Universal User Interface App, we will develop a de facto standard universal remote control App (“URCA”) for all Smart TV manufactured by different manufacturers.

Many App developers may develop remote control App for Smart TVs on particular OS platform. These Apps may have different user interface and the user may have to use different user interface each time they change to a Smart TV manufactured by different manufacturers.

With the URCA, you can turn your mobile devices such as smart phones, iPod touch, iPod, tablets and etc. into a universal remote control for all Smart TVs.

The App is linked to a database (or databases) contains drivers for a large number of different Smart TV manufactured by different manufacturers worldwide.

In operating the URCA, after installing UUIA to a mobile device the user indicate name of the manufacturer then the model number of a Smart TV purchased by the user.

The computer/server then searches the database to retrieve appropriate driver for the Smart TV. A user can install multiple drivers from different manufacturers in URCA.

Mobile device with URCA will act like a remote control for the Smart TV and controls volume, change channels, and most of the features that regular remote control can perform. It can be used as keyboard, touch pad and gyration mouse for Smart TV. A user is using same or very similar user interfaces (menus) regardless of the manufacturer and model number of the Smart TV.

By being able to use same or very similar user interfaces for all Smart TV, user does not have to learn how to use different remote control App each time the user changes the manufacturers or the model of smart TV.

With both time and energy being valuable and diminishing resources, it is logical to have total access to your home from anywhere and anytime. You can monitor and control different type of connected devices such as lights, thermostat for heating and air conditioner, wall power outlets, water sprinkler system, stove, oven, security cameras, door/window opening sensors, motion sensors, garage doors, smoke detectors, window shutter controls, and etc. for your home remotely via internet with mobile device.

With that in mind and as part of a category for Universal User Interface App (“UUIA”), we will develop a Universal Home Power Control Module App (“HPCM”) for monitoring and controlling all of connected devices for home remotely via internet with mobile device.

The App is linked to a database (or databases) contains drivers for a large number of different connected devices manufactured by different manufacturers worldwide.

In operating the HPCM, after installing UUIA to a mobile device the user indicate the category and type of connected device, name of manufacturer then model number of desired connected device.

The computer/server then searches the database to retrieve appropriate driver. A user can install multiple drivers to each type of connected device manufactured by different manufacturers.

Mobile device with HPCM, a user can change temperature or set schedule for water heater, monitor home through ip cameras at home, open or close garage door, turn on or off stove at home and set schedule for water sprinkler system at home remotely via internet with mobile device. And many more can be done.

Each type of connected device, a user use same or very similar user interfaces (menus) regardless of the manufacturer and model number of connected devices.

By being able to use same or very similar user interfaces for connected devices for home, a user does not have to learn how to use each type of connected device manufactured by different manufacturers.

After installing different categories of connected device for Universal User Interface App (“UUIA”), a user may have a lot of important private information into a mobile device. For the security purpose, a user has an option to select an isecure. isecure is an App which a user can control UUIA from remote computer via internet in case of lost, stolen or misplaced their mobile device. A user can sign up for isecure anytime after they install UUIA to their mobile device and create a user account. A user account can be created by entering user id and password, then some private security questions such as birth date, driver license number and/or answering some questionnaires.

In case of lost, stolen, or misplaced their mobile device, a user can login to isecure and answer security questions, then a user can make a request to freeze the use of UUIA for certain period of time or halt the operation permanently or delete important information from mobile device permanently for further use by thieves. After the request, web server will send signal via internet to freeze the operation for period of time, halt or delete important information from the mobile device permanently. A user has an option to save important private information to web server in case they need to reinstall the UUIA to their new or other mobile device.

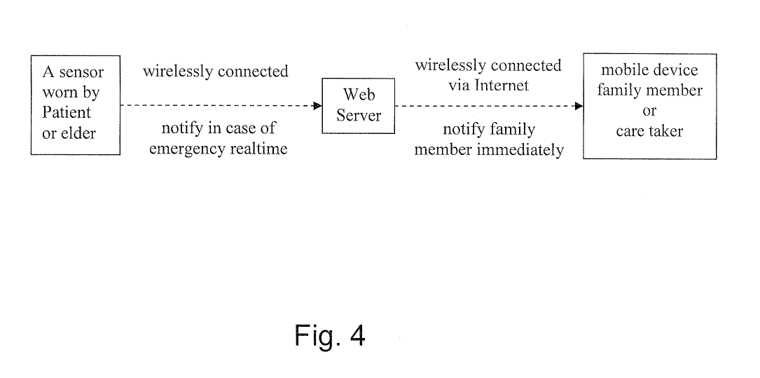

FIG. 4 shows a Health Alert System App (HASA).

We will connect to devices that measure an individual's heart rate, blood pressure, blood glucose levels, etc. Solutions come in the form of sensors worn by patient to measure their vital signs and wirelessly transmit the data to the webserver, then notify family member or caretaker remotely and realtime or their mobile devices. Alsom connect to a sensor that can senses fall by eleder and transmit warning signal wirelessly to a mobile device of family member or caretaker.

The manufacturer of connected device is the company name on the product and they may not be the original manufacturer. However they are the one who designed the product and release SDK. For example, Apple® may not be the original manufacturer of iPhone®. They are subcontracting a company in China. However, we are considering Apple as a manufacturer of iPhone®.

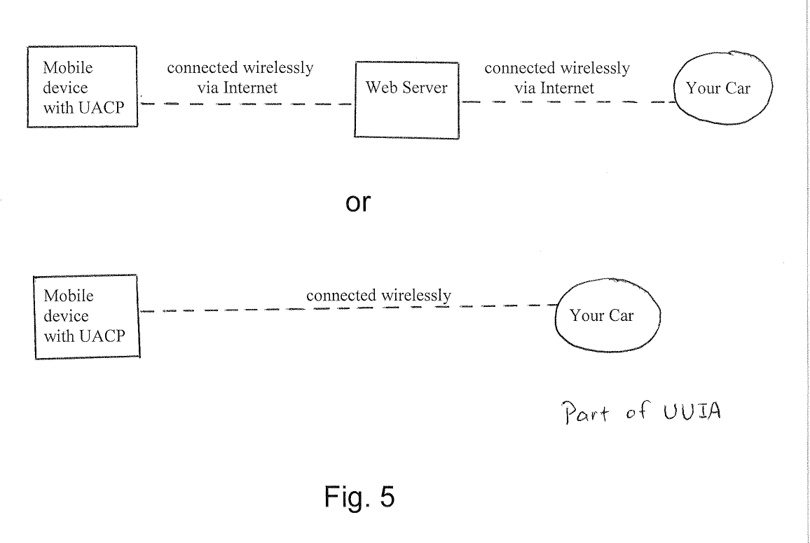

FIG. 5 shows a Universal Auto Control App (UACP).

You can use mobile device as remote control for your car. You can monitor and control your car remotely (wirelessly) via Internet.

With UACP, mobile device can open door, lock doors, start engine, thrn off engines, open trunk, and all that can be done with your existing auto remote control. You can monitor tire pressure, play car stereo, etc. Address book on mobile device can be transferred to GPS with a click tyouch of button.

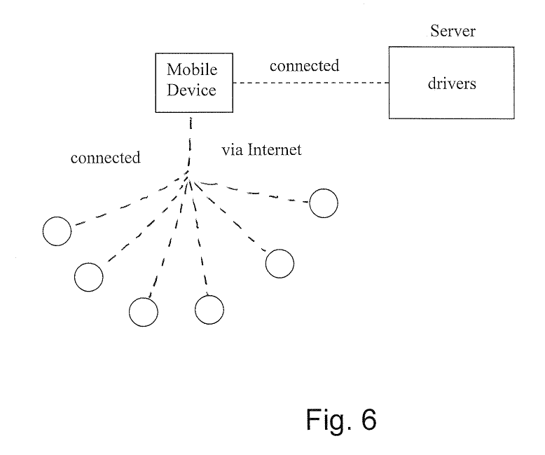

FIG. 6 shows a Universal Order on the go App (UOGA).

You can order food, coffee from mobile device. Do not want to wait in drive in or walk in to McDonald's®, Burger King®, Carls Jr®, Starbucks®, Coffe Bean®, etc. (fastfood franchises, coffee shops, etc.) waiting line to order food, coffee, etc.

You can order from mobile device and pick up from Drive in or counters inside by giving confirmation number given or displayed on the mobile device.

UOGA will display nearby shops by customer's preference a user indicates by name, location nearby, type of food, etc.

Then mobile device display nearby shops and user select the shop. The mobile device display menus to select from, then the user selects and send orders to the shop. Mobile devices display confirmation number so that the user can use the confirmation number to pick up order.

A user can configure favorite. The favorite can be predefined by the user by indicating them.

For example, the user can set if they want to have in their hamburfer such as no onion, add cheese, etc. So the user can select favorite and add quantity and order is completed with click of two simple touches. Order can hbe paid by credit card online. Credit card information can be preentered and multiple card can be entered. The user can pay by single touch of selection of payment method.

Also, particular shop can be set as favorite. Any of Burgerking®, McDonald's®, Starbucks®that you go most, you can set it as favorite.

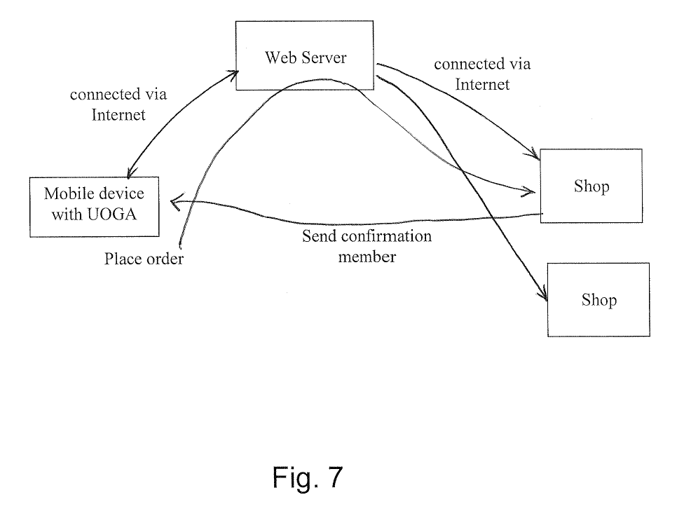

The procedure can be as follows referring to FIG. 7.

1) Select shops/will display menus for selected shop.

2) Place an order (you can set the time to pick up).

3) Indicate method of payment.

4) Receive confirmation number from a shop.

5) Pick up order by presenting confirmation number at the counter or drive in.

A mobile device with a UUIA software installed can download and install a specific driver for connected devices as follows.

1) User select desired category of a connected device from the UUIA menu.

2) UUIA connects to a webserver.

3) The mobile device displays a list of manufacturere of the connected device available.

4) User selects the manufacturer.

5) The mobile device displays list of model numbers of the connected device available.

6) User selects the model number.

7) UUIA downloads desired driver.

An aspect of the invention provides a method for universal user interface.

The method comprises steps for:

downloading from a web server and installing a universal user interface App software (UUIA) to a mobile device of a user;

the user's indicating a type of a connected device on the UUIA;

the mobile device's being connected to a web server;

the user's identifying the connected device on the UUIA;

the web server's searching a database to retrieve and install a driver for the connected device;

the user's selecting the type of the connected device on the UUIA; and

the UUIA's providing a universal user interface for the connected device on the mobile device.

The step of downloading may comprise a step of accessing the Internet.

The type of connected device may comprise a smart TV, a home security system, and a home power control module.

The mobile device may be configured to perform functions of a remote controller for the smart TV, and wherein the functions comprises controlling volume and changing channels.

The mobile device may be configured to perform functions of a keyboard, a touch pad, and a gyration mouse for the smart TV.

The functions may be provided though interface of the mobile device, and the interface of the mobile device may comprise a touch screen, a plurality of buttons, and a plurality of speakers and microphones.

The mobile device may be configured to perform functions for the home security system and the universal home power control module of a house, and the functions may comprise changing temperature of the house, setting schedule for a water heater in the house, monitoring the house using IP cameras installed in the house, open/closing a garage door, turning on or off a stove in the house, and setting schedule for a water sprinkler system in the house.

The database may be provided in the web server.

The step of identifying may comprise a step of selecting a name of manufacturer and a model number of the connected device.

The step of downloading may comprise a step of the user's indicating an OS platform of the mobile device.

The universal user interface may be substantially same for the connected devices of different manufacturers and models.

The method may further comprise a step of controlling the UUIA from a remote computer via the Internet.

The step of controlling may comprise steps for:

signing up on the UUIA and the web server after installing the UUIA in the mobile device;

creating a user account with a user ID and a password;

logging in to the user account; and

performing controlling functions.

The controlling functions may comprise functions for:

freezing the use of the UUIA for a certain period of time;

halting the operation of the UUIA permanently;

recovering information from the mobile device and storing the information in the web server; and

deleting information in the mobile device.

Another aspect of the invention provides a universal user interface system, comprising:

a mobile device;

a UUIA installed in the mobile device; and

a web server having a database having a plurality of drivers for a plurality of connected devices,

wherein the UUIA provides a universal user interface for the connected devices of a given type,

wherein the UUIA is downloaded from the web server and installed in the mobile device,

wherein the UUIA accesses the web server and downloads a driver for a connected device therefrom.

The connected device may comprise a smart TV, a home security system, and a home power control module.

The system may further comprise a isecure module for accessing and controlling the UUIA of the mobile device from a remote computer.

The isecure module may be for signing up on the UUIA and the web server after installing the UUIA in the mobile device, creating a user account with a user ID and a password, logging in to the user account, and performing controlling functions.

The controlling functions may include:

freezing the use of the UUIA for a certain period of time;

halting the operation of the UUIA permanently;

recovering information from the mobile device and storing the information in the web server; and

deleting information in the mobile device.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed:

1. A method for universal user interface comprising steps for:
downloading from a web server and installing a universal user interface App software (UUIA) to a mobile device of a user;
the user's indicating a type of a connected device on the UUIA;
the mobile device's being connected to a web server;
the user's identifying the connected device on the UUIA;
the web server's searching a database to retrieve and install a driver for the connected device;
the user's selecting the type of the connected device on the UUIA; and
the UUIA's providing a universal user interface for the connected device on the mobile device.

2. The method of claim 1, wherein the step of downloading comprises a step of accessing the Internet.

3. The method of claim 1, wherein the type of connected device comprises a smart TV, a home security system, and a home power control module.

4. The method of claim 3, wherein the mobile device is configured to perform functions of a remote controller for the smart TV, and wherein the functions comprises controlling volume and changing channels.

5. The method of claim 3, wherein the mobile device is configured to perform functions of a keyboard, a touch pad, and a gyration mouse for the smart TV.

6. The method of claim 5, wherein the functions are provided though interface of the mobile device, and wherein the interface of the mobile device comprises a touch screen, a plurality of buttons, and a plurality of speakers and microphones.

7. The method of claim 3, wherein the mobile device is configured to perform functions for the home security system and the universal home power control module of a house, and wherein the functions comprises changing temperature of the house, setting schedule for a water heater in the house, monitoring the house using IP cameras installed in the house, open/closing a garage door, turning on or off a stove in the house, and setting schedule for a water sprinkler system in the house.

8. The method of claim 1, wherein the database is provided in the web server.

9. The method of claim 1, wherein the step of identifying comprises a step of selecting a name of manufacturer and a model number of the connected device.

10. The method of claim 1, wherein the step of downloading comprises a step of the user's indicating an OS platform of the mobile device.

11. The method of claim 1, wherein the universal user interface is substantially same for the connected devices of different manufacturers and models.

12. The method of claim 1, further comprising a step of controlling the UUIA from a remote computer via the Internet.

13. The method of claim 12, wherein the step of controlling comprises steps for:
signing up on the UUIA and the web server after installing the UUIA in the mobile device;
creating a user account with a user ID and a password;
logging in to the user account; and
performing controlling functions.

14. The method of claim 13, wherein the controlling functions comprises functions for:
freezing the use of the UUIA for a certain period of time;
halting the operation of the UUIA permanently;
recovering information from the mobile device and storing the information in the web server; and
deleting information in the mobile device.

15. A universal user interface system comprising:
a mobile device;
a UUIA installed in the mobile device; and
a web server having a database having a plurality of drivers for a plurality of connected devices,
wherein the UUIA provides a universal user interface for the connected devices of a given type,
wherein the UUIA is downloaded from the web server and installed in the mobile device,
wherein the UUIA accesses the web server and downloads a driver for a connected device therefrom.

16. The system of claim 15, wherein the connected device comprises a smart TV, a home security system, and a home power control module.

17. The system of claim 15, further comprising a isecure module for accessing and controlling the UUIA of the mobile device from a remote computer,
wherein the isecure module is for signing up on the UUIA and the web server after installing the UUIA in the mobile device, creating a user account with a user ID and a password, logging in to the user account, and performing controlling functions,
wherein the controlling functions includes:
freezing the use of the UUIA for a certain period of time;
halting the operation of the UUIA permanently;
recovering information from the mobile device and storing the information in the web server; and
deleting information in the mobile device.
